(19) United States
(12) Patent Application Publication
(10) Pub. No.: US 2005/0005502 A1
(43) Pub. Date: Jan. 13, 2005

(54) Insect barrier permitting downward travel of insects

(75) Inventor: James D. Thompson, London (CA)

Correspondence Address: ANISSIMOFF & ASSOCIATES;RICHMOND NORTH OFFICE CENTRE, SUITE 201, 235 NORTH CENTRE RD., LONDON, ON, N5X 4E7, CA

(73) Assignee: Envirometrics Systems Inc.

(21) Appl. No.: 10/854,271

(22) Filed: May 27, 2004

Related U.S. Application Data
(60) Provisional application No. 60/473,131, filed on May 27, 2003.

(51) Int. Cl. A01M 1/18

(52) U.S. Cl. 43/108

(57) ABSTRACT

An insect barrier permitting the downward travel of insects, particularly gypsy moths, over the barrier but preventing insects from travelling upwardly over the barrier. The barrier comprises a contact means for engagement with a tree and a cylindrical portion spaced apart from the tree by the thickness of the contact means. Within the interior of the barrier is a means for preventing the travel of insects. A downwardly sloped conical portion is provided, preferably above the cylindrical portion, having an outer surface permitting the travel of insects thereon. Gypsy moth larvae are permitted to pass over the insect barrier in their daily migration down the tree, but are prevented from ascending past the barrier to re-infest the tree.

### CROSS REFERENCE TO RELATED APPLICATIONS

This application claims the benefit of U.S. patent application Ser. No. 60/473,131, filed May 27, 2003.

### FIELD OF INVENTION

The invention relates to insect barriers for use in protecting trees from infestation by crawling insects. More particularly, the invention relates to an insect barrier that permits downward travel of insects over the barrier to permit the insect to leave the upper regions of the tree, but prevents upward travel of the insects and re-infestation of the tree.

### BACKGROUND OF THE INVENTION

Insect infestation of trees results in widespread environmental and property damage and is a significant problem worldwide. Particularly, insect infestation by crawling insects, including larvae or pupae of flying insects, causes damage to trees that often results in death of the trees. A notable example of such a crawling insect is the gypsy moth larvae.

Tree barriers for use in protecting trees from insect infestation have been used. The barrier is typically applied around the trunk of the tree and may comprise a slippery, sticky, or toxic surface to prevent the passage of insects over the barrier. An example of such a barrier may be found in international patent application WO 02/32221 A2, filed on Oct. 18, 2001 by the inventor of the present invention, which is hereby incorporated by reference. These types of barriers are effective at preventing the travel of insects over the barrier in both the upward and downward direction of travel.

In the case of gypsy moth larvae, the larvae migrate daily from the upper regions of the tree downwardly to ground level and back up again. A barrier that prevents the travel of insects in both the downward and upward directions prevents the larvae from leaving the tree, resulting in a continued infestation of the upper regions of the tree. The need therefore exists for an insect barrier for attachment to a tree that permits the insects to leave the tree by downward migration over the barrier, but prevents the insects from re-infesting the tree by upward migration.

### SUMMARY OF THE INVENTION

According to an aspect of the invention, there is provided an insect barrier for attachment to a tree for preventing the travel of insects upwardly over the barrier and for permitting the travel of insects downwardly over the barrier, the barrier comprising: a downwardly sloped conical portion having a lower part in spaced apart relation to the tree, the conical portion further having an outer surface permitting the travel of gypsy moths thereon; an interior having means for preventing the travel of insects; and, a contact means within the interior for engagement with the tree to prevent the passage of insects between the barrier and the tree, the contact means comprising a layer of non-woven fabric material having a deformable thickness.

According to another aspect of the invention, there is provided an insect barrier for attachment to a tree for preventing the travel of insects upwardly over the barrier and for permitting the travel of insects downwardly over the barrier, the barrier comprising: a contact means engaged with the tree to prevent the passage of insects between the barrier and the tree; a cylindrical portion in contact with the contact means and in spaced apart relation to the tree, the cylindrical portion having an outer surface permitting the travel of insects thereon and a downwardly extending portion extending downwardly from the contact means with an inner surface facing an interior cavity of the barrier; a means for preventing the travel of insects thereon within the interior cavity; and, a downwardly sloped conical portion above the cylindrical portion having a lower part in contact with the cylindrical portion, the conical portion having an outer surface permitting the travel of insects thereon.

According to yet another aspect of the invention, there is provided a method of attaching an insect barrier to a tree, the insect barrier for preventing the travel of insects upwardly over the barrier and for permitting the travel of insects downwardly over the barrier, the method comprising: installing a cylindrical portion of the barrier having an outer surface permitting the travel of insects thereon around the circumference of the tree in spaced apart relation thereto, thereby engaging a contact means of the barrier with the tree to prevent the passage of insects between the barrier and the tree, the cylindrical portion having a downwardly extending portion extending downwardly from the contact means with an inner surface facing an interior cavity of the barrier, the barrier having means within the interior cavity for preventing the travel of insects; wrapping a film material having a surface permitting the travel of insects thereon around an upper part of the cylindrical portion; and, winding the film material upwardly around the tree to thereby form a downwardly sloped conical portion of the barrier about the tree.

An insect barrier made according to the present invention has surprisingly improved efficacy for gypsy moths over prior art insect barriers, since the moth larvae are permitted to exit the tree by travelling downwardly over the barrier during their daily migration, but are prevented from travelling upwardly over the barrier to re-infest the tree.

The barrier comprises a contact means for engagement with the tree to occupy any voids caused by surface irregularities. The contact means prevents insects from passing between the barrier and the tree through the voids. The contact means preferably has a deformable thickness for engagement with the surface of the tree. In one embodiment, the contact means is a non-woven fabric. The non-woven fabric is preferably made of a plastic or a fiberglass material. In another embodiment, the contact means is a foamed plastic, such as open celled styrofoam or neoprene foam. In yet another embodiment, the contact means is an adhesive paste, such as a silicone sealant. The contact means may be used in attaching the insect barrier to the tree.

Exterior of the contact means, the insect barrier comprises a cylindrical portion having an outer surface permitting the travel of insects thereon. The cylindrical portion is spaced apart from the tree by the thickness of the contact means. The cylindrical portion may have a height greater than the height of the contact means. The cylindrical portion is attached to the contact means (for example, by an adhesive) and a portion thereof may extend downwardly past the contact means. The space between this downwardly extending portion and the tree defines an interior cavity of the insect barrier. The downwardly extending portion has an inner surface facing the interior cavity.

Within the interior of the insect barrier is a means for preventing the travel of insects. The means for preventing the travel of insects may be applied within the interior cavity and may comprise a slippery material, a sticky material, and/or a toxic material. Preferably, the means for preventing the travel of insects is a sticky material applied to the inner surface of the downwardly extending portion. Alternatively, the means for preventing the travel of insects may be a band of a sticky and/or toxic material applied to the surface of the tree within the interior of the insect barrier; in this embodiment, the conical portion also helps shelter the band of material from the elements. When traveling up the tree, insects are prevented from travelling over the barrier from a position below the barrier to a position above the barrier by the means for preventing travel of insects. This prevents infestation of the tree by insects ascending from the ground.

The downwardly sloped conical portion has an outer surface that permits passage of insects, thereby allowing the insects to travel downwardly over the barrier to leave the tree. The outer surface may have properties that facilitate the ability of the insect to travel over the surface; for example, the surface may have tactile features or properties that permit insects, particularly gypsy moth larvae, to find traction when travelling on the surface.

The conical portion may be made from any suitable material, for example, a plastic material. Preferably, the conical portion is formed using a band of stretchable film material wrapped around at least an upper part of the cylindrical portion and wound upwardly around the tree to form a downwardly sloped conical portion. In this embodiment, the lower part of the conical portion is in contact with the upper part of the cylindrical portion and the upper part of the conical portion may be in contact with either the contact means or the tree. Alternatively, the conical portion may be integrally formed with the cylindrical portion. The conical portion may comprise a composite material formed using, for example, a plastic surface placed overtop of a substrate material having desirable structural properties. Examples of plastic materials suitable for use include: vinylidene chloride, including ethylene vinylidene chloride; vinyl chloride; or, polymers and co-polymers thereof. These may be found in plastic films used, for example, in food wrap. Other examples include polyethylene films made from, for example low density polyethylene (LDPE), linear low density polyethylene (LLDPE), or co-polymers thereof. These may be found in plastic films used, for example, in shrink wrap packaging.

Surprisingly, it has been found that plastic film of the type used in shrink wrap packaging has the desired property of permitting the travel of insects on its surface. This type of polyethylene film also has sufficient elasticity to permit stretching and frictional engagement of the wrap with the tree, obviating the need for adhesives or fasteners for the upper part of the conical portion.

### BRIEF SUMMARY OF THE INVENTION

Having regard to the foregoing, preferred embodiments of the invention will be described with reference to the accompanying drawings, in which:

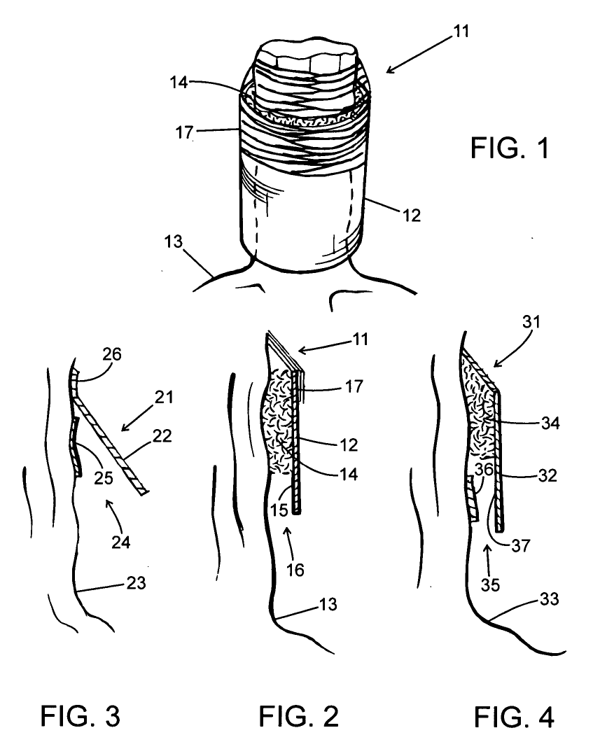

FIG. 1 is a perspective view of an embodiment of an insect barrier according to the present invention;

FIG. 2 is a side view of the embodiment shown in FIG. 1;

FIG. 3 is a side view of another embodiment of an insect barrier according to the present invention; and,

FIG. 4 is a side view of yet another embodiment of an insect barrier according to the present invention.

### DESCRIPTION OF THE PREFERRED EMBODIMENTS

Referring to the embodiment of the insect barrier shown in FIGS. 1 & 2, the insect barrier has a downwardly sloped conical portion (11) situated above a substantially vertical cylindrical portion (12). The barrier has a contact means (14) adhesively applied to the cylindrical portion (12) and frictionally engaged with a tree (13). The contact means (14) is a non-woven fabric having a deformable thickness that is made from a plastic material. A portion of the cylindrical portion (12) extends downwardly past the contact means (14). An inner surface (15) of the downwardly extending portion defines a boundary of an interior cavity (16) of the insect barrier. The means for preventing travel of insects is applied to the inner surface (15) within the interior cavity (16). In this embodiment, the means for preventing the travel of insects is a sticky substance applied to the inner surface (15), such as a thin layer of an adhesive. In an alternate embodiment, the means for preventing the travel of insects is a slippery surface property of the inner surface (15) provided, for example, by a coating of a fluoropolymer, such as PTFE. The cylindrical portion (12) is first installed on the tree (13) with the contact means (14) in engagement with the tree and is thereby spaced apart from the tree by the thickness of the contact means. The conical portion (11) is subsequently formed by wrapping a plastic film around the upper part (17) of the cylindrical portion, then winding the film around the tree. The upper part of the conical portion (11) is in contact with the tree and the lower part of the conical portion is in contact with the upper part of the cylindrical portion (12). The conical portion (11) has an outer surface with properties that permit the travel of insects, particularly gypsy moth larvae, thereon.

Referring to FIG. 3, another embodiment of the insect barrier comprises a conical portion (21) having an outer surface (22) permitting the downward travel of insects thereon. A cylindrical portion (26) is integrally formed with the conical portion (21) and is adhesively attached to a tree (23) using an adhesive paste contact means (not shown). An interior (24) is defined between the insect barrier and the tree (23). A band of sticky material (25), for example Tanglefoot™, is applied circumferentially about the tree (23) within the interior (24). The conical portion (21) serves the dual function of permitting the downward travel of insects over the band of sticky material (25) and of sheltering the band of sticky material (25) from the elements.

Yet another embodiment of the invention is shown with reference to FIG. 4. The insect barrier comprises a conical portion (31) that is integrally formed with a cylindrical portion (32) and applied about the circumference of a tree (33). A contact means (34) is adhesively attached to the conical portion (31) and the cylindrical portion (32) and frictionally engaged against the tree (33) to prevent the passage of insects between the insect barrier and the tree. The cylindrical portion (32) extends downwardly past the contact means (34) to form an interior cavity (35) of the insect barrier. Within the interior cavity (35) a band of sticky material (36) is applied circumferentially about the surface of the tree (33) to prevent the upward travel of insects over the barrier. A slippery surface may optionally be applied to an inner surface (37) of the downwardly extending portion and used in addition to the band of sticky material (36) to prevent the upward travel of insects over the barrier. The conical portion (31) has an outer surface with properties that permit the downward passage of insects over the barrier.

### EXAMPLE

Qualitative tests were performed using an insect barrier according to FIGS. 1 & 2 as described above. A structure comprising a contact means of a non-woven fabric material, a cylindrical portion adhesively attached thereto, and a downwardly extending portion with a sticky inner surface, was frictionally engaged circumferentially around a tree. A band of polyethylene shrink wrap film was tightly wrapped around the upper 1.5 inches of the structure and wound about the tree to form a downwardly sloped conical portion above the cylindrical portion. The shrink wrap packaging was sold under the brand name Stretch Film™ and had a width of 3 inches and a nominal thickness of 0.80 mil. The insect barrier had surprising efficacy against gypsy moth larvae, which were observed in their daily migration to pass downwardly over the insect barrier to leave the tree, but could not ascend past the insect barrier to re-infest the tree due to the sticky inner surface of the downwardly extending portion.

1. An insect barrier for attachment to a tree for preventing the travel of insects upwardly over the barrier and for permitting the travel of insects downwardly over the barrier, the barrier comprising:
a) a contact means engaged with the tree to prevent the passage of insects between the barrier and the tree;
b) a cylindrical portion in contact with the contact means and in spaced apart relation to the tree, the cylindrical portion having an outer surface permitting the travel of insects thereon and a downwardly extending portion extending downwardly from the contact means with an inner surface facing an interior cavity of the barrier;
c) a means for preventing the travel of insects thereon within the interior cavity; and,
d) a downwardly sloped conical portion above the cylindrical portion having a lower part in contact with the cylindrical portion, the conical portion having an outer surface permitting the travel of insects thereon.

2. An insect barrier according to claim 1, wherein the contact means comprises a layer of non-woven fabric material having a deformable thickness.

3. An insect barrier according to claim 1, wherein the means for preventing the travel of insects thereon is on the inner surface of the downwardly extending portion.

4. An insect barrier according to claim 1, wherein the means for preventing the travel of insects thereon is on the tree within the interior cavity.

5. An insect barrier according to claim 1, wherein the means for preventing the travel of insects thereon is a sticky material.

6. An insect barrier according to claim 1, wherein the means for preventing the travel of insects is a slippery material.

7. An insect barrier according to claim 1, wherein the means for preventing the travel of insects is a toxic material.

8. An insect barrier according to claim 1, wherein the conical portion has an upper part in contact with the tree.

9. An insect barrier according to claim 1, wherein the conical portion is integral with the cylindrical portion.

10. An insect barrier according to claim 1, wherein the conical portion is formed from a band of material wrapped around the cylindrical portion.

11. An insect barrier according to claim 1, wherein the conical portion is made from a stretchable film material.

12. An insect barrier according to claim 1, wherein the conical portion is made from a polyethylene material.

13. An insect barrier according to claim 1, wherein insects are prevented from travelling upwardly over the barrier from a position below the barrier to a position above the barrier and permitted to travel downwardly over the barrier from a position above the barrier to a position below the barrier.

14. An insect barrier according to claim 1, wherein the insects are gypsy moth larvae.

15. A method of attaching an insect barrier to a tree, the insect barrier for preventing the travel of insects upwardly over the barrier and for permitting the travel of insects downwardly over the barrier, the method comprising:
a) installing a cylindrical portion of the barrier having an outer surface permitting the travel of insects thereon around the circumference of the tree in spaced apart relation thereto, thereby engaging a contact means of the barrier with the tree to prevent the passage of insects between the barrier and the tree, the cylindrical portion having a downwardly extending portion extending downwardly from the contact means with an inner surface facing an interior cavity of the barrier, the barrier having means within the interior cavity for preventing the travel of insects;
b) wrapping a film material having a surface permitting the travel of insects thereon around an upper part of the cylindrical portion; and,
c) winding the film material upwardly around the tree to thereby form a downwardly sloped conical portion of the barrier about the tree.

16. An insect barrier for attachment to a tree for preventing the travel of insects upwardly over the barrier and for permitting the travel of insects downwardly over the barrier, the barrier comprising:
a) a downwardly sloped conical portion having a lower part in spaced apart relation to the tree, the conical portion further having an outer surface permitting the travel of gypsy moths thereon;
b) an interior having means for preventing the travel of insects; and,
c) a contact means within the interior for engagement with the tree to prevent the passage of insects between the barrier and the tree, the contact means comprising a layer of non-woven fabric material having a deformable thickness.
